(19) United States
(12) Patent Application Publication
(10) Pub. No.: US 2009/0232535 A1
(43) Pub. Date: Sep. 17, 2009

(54) FIXING APPARATUS

(75) Inventors: Yoshinori Tsueda, Fuji-shi (JP); Satoshi Kinouch, Shinjuki-ku (JP); Toshihiro Sone, Yokohama-shi (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/401,244

(22) Filed: Mar. 10, 2009

Related U.S. Application Data
(60) Provisional application No. 61/035,685, filed on Mar. 11, 2008.
(60) Provisional application No. 61/039,395, filed on Mar. 25, 2008.

(51) Int. Cl. G03G 15/20

(52) U.S. Cl. 399/69; 399/329

(57) ABSTRACT

The present invention provides a technique to make uniform a temperature distribution of a sheet heating temperature in a sheet widthwise direction, with no relation to sizes in a direction (sheet widthwise direction) orthogonal to a carrying direction of sheets to be fixed.

In a fixing device according to the present invention including a first roller; a second roller configured to rotate with respect to a rotational axis parallel to a rotational axis of the first roller; a belt configured to have a conductive layer and be rolled on the first roller and the second roller; an induction heating coil configured to heat the belt; a heat pipe configured to be disposed inside the second roller and extend toward the rotational axis of the second roller; a third roller configured to press a roller surface of the first roller through the belt, to nip and carry a sheet to be treated in cooperation with a belt surface of the belt; and a temperature sensor configured to sense a temperature of the belt surface of the belt, the temperature sensor sensing a temperature of the belt surface, the second roller giving a tension to the belt and the induction heating coil heating the belt surface are conducted at different positions in a circumferential direction of the first roller.

### CROSS-REFERENCE TO RELATED APPLICATION

This application is based upon and claims the benefit of priority from: U.S. provisional application 61/035685, filed on Mar. 11, 2008, and U.S. provisional application 61/039396, filed on Mar. 25, 2008, the entire contents of each of which are incorporated herein by reference.

### TECHNICAL FIELD

The present invention relates to a technique to heat and fix a development agent image on a sheet, and more in particular, to a technique to make uniform a temperature distribution of a sheet heating temperature in a sheet widthwise direction.

### BACKGROUND

Conventionally, a fixing device is known, which includes a fixing roller which is heated, a tension roller, a belt rolled on the fixing roller and the tension roller and a press roller for nipping and carrying a sheet in cooperation with a belt surface of the corresponding belt.

In such fixing device, a configuration is known where an induction heating coil is disposed at the outside of a fixing roller, and the induction heating coil heats the fixing roller (for example, see Japanese Patent Application Laid-open No. 2006-267643).

In the conventional fixing device, however, uniformity of a temperature distribution in a widthwise direction of a belt surface is not considered upon heating and fixing a small sized sheet in a direction (widthwise direction) orthogonal to a sheet carrying direction. In other words, when a small sized sheet is heated and fixed in a widthwise direction in the conventional fixing device, an area contact with the sheet and an area non-contact with the sheet in the widthwise direction are very different in a heat amount which they take away from the belt surface and thereby a temperature distribution therebetween is not uniform. The un-uniformity of a temperature distribution of the belt surface in the widthwise direction is in danger of causing deterioration (deterioration of image quality of a development agent image formed on a sheet) of a fixing performance of the fixing device.

### SUMMARY

The embodiments of present invention is directed to providing a technique to make uniform a temperature distribution of a sheet heating temperature in a sheet widthwise direction, with no relation to sizes in a direction (sheet widthwise direction) orthogonal to a carrying direction of sheets to be fixed.

In order to solve the above-described problems, an aspect of the present invention relates to a fixing device including: a first roller; a second roller configured to rotate with respect to a rotational axis parallel to a rotational axis of the first roller; a belt configured to have a conductive layer and be rolled on the first roller and the second roller; an induction heating coil configured to heat the belt; a heat pipe configured to be disposed inside the second roller and extend toward the rotational axis of the second roller; a third roller configured to press a roller surface of the first roller through the belt, to nip and carry a sheet to be treated in cooperation with a belt surface of the belt; and a temperature sensor configured to sense a temperature of the belt surface of the belt, wherein the temperature sensor, the second roller and the induction heating coil are disposed at different positions in a circumferential direction of the first roller.

An aspect of the present invention relates to a fixing method in a fixing device including: a first roller; a second roller configured to rotate with respect to a rotational axis parallel to a rotational axis of the first roller; a belt configured to have a conductive layer and be rolled on the first roller and the second roller; an induction heating coil configured to heat the belt; a heat pipe configured to be disposed inside the second roller and extend toward the rotational axis of the second roller; a third roller configured to press a roller surface of the first roller through the belt, to nip and carry a sheet to be treated in cooperation with a belt surface of the belt; and a temperature sensor configured to sense a temperature of the belt surface of the belt, wherein the temperature sensor sensing a temperature of the belt surface, the second roller giving a tension to the belt and the induction heating coil heating the belt surface are conducted at different positions in a circumferential direction of the first roller.

In order to solve the above-described problems, an aspect of the present invention relates to a fixing device including: a first roller; a second roller configured to rotate with respect to a rotational axis parallel to a rotational axis of the first roller; a belt configured to have a conductive layer and be rolled on the first roller and the second roller; an induction heating coil configured to heat the belt; a heat pipe configured to be disposed inside the second roller and extend toward the rotational axis of the second roller; a third roller configured to press a roller surface of the first roller through the belt, to nip and carry a sheet to be treated in cooperation with a belt surface of the belt; and a temperature sensor configured to sense a temperature of the belt surface of the belt, wherein the temperature sensor, the second roller and the induction heating coil are disposed at different positions in a circumferential direction of the first roller, and a size in a direction of a rotational axis of the belt is smaller than any size of the first roller, the second roller and the heat pipe in the direction of the rotational axis.

An aspect of the present invention relates to a fixing method in a fixing device including: a first roller; a second roller configured to rotate with respect to a rotational axis parallel to a rotational axis of the first roller; a belt configured to have a conductive layer and be rolled on the first roller and the second roller; an induction heating coil configured to heat the belt; a heat pipe configured to be disposed inside the second roller and extend toward the rotational axis of the second roller; a third roller configured to press a roller surface of the first roller through the belt, to nip and carry a sheet to be treated in cooperation with a belt surface of the belt; and a temperature sensor configured to sense a temperature of the belt surface of the belt, a size in a direction of a rotational axis of the belt being smaller than any size of the first roller, the second roller and the heat pipe in the direction of the rotational axis in the device, wherein the temperature sensor sensing a temperature of the belt surface, the second roller giving a tension to the belt and the induction heating coil heating the belt surface are conducted at different positions in a circumferential direction of the first roller.

### DESCRIPTION OF THE DRAWINGS

FIG. 1 is a longitudinal cross-sectional view to illustrate a schematic configuration of an image forming apparatus (MFP: Multi Function Peripheral) including a fixing device according to a first embodiment of the present invention;

FIG. 2 is a longitudinal cross-sectional view to illustrate a schematic configuration of the fixing device according to the first embodiment of the present invention;

FIG. 3 is a view to explain an internal configuration of a tension roller;

FIG. 4 is a schematic view to illustrate a relation of lengths in a direction of rotational axis of the tension roller, an area heated by an induction heating coil, a belt, and a heat pipe;

FIG. 5 is a graph to illustrate a temperature distribution in a direction of rotational axis of a belt surface of the belt when a narrow sheet is fixed in a configuration of not providing the heat pipe to the tension roller;

FIG. 6 is a graph to illustrate a temperature distribution in a direction of rotational axis of a belt surface of the belt when a narrow sheet is fixed in a configuration of providing the heat pipe to the tension roller;

FIG. 7 is a longitudinal cross-sectional view to illustrate a schematic configuration of a fixing device 7b according to a second embodiment of the present invention; and

FIG. 8 is a longitudinal cross-sectional view to illustrate a schematic configuration of a fixing device 7c according to a third embodiment of the present invention.

### DETAILED DESCRIPTION

Hereinafter, embodiments of the present invention will be described with reference to the accompanying drawings.

### First Embodiment

First, a first embodiment of the present invention will now be described.

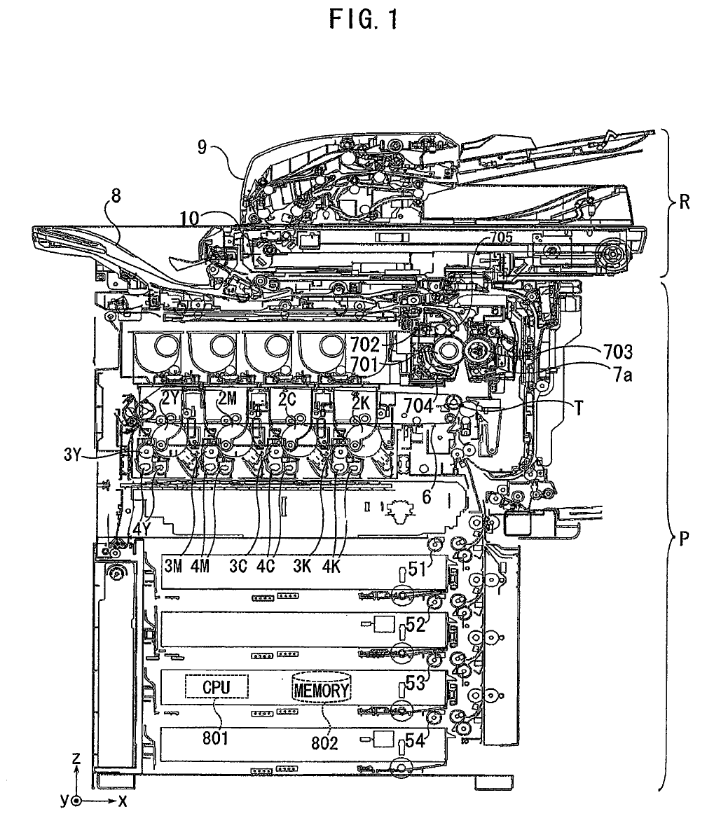

FIG. 1 is a longitudinal cross-sectional view to illustrate a schematic configuration of an image forming apparatus (MFP: Multi Function Peripheral) including a fixing device according to a first embodiment of the present invention.

As shown in FIG. 1, an image forming apparatus according to the present embodiment includes an image read-out unit R and an image forming unit P.

The image read-out unit R reads out images of an original document of a sheet and an original document of a book through scanning.

The image forming unit P forms a development agent image on a sheet on the basis of the images read out from an original document by the image read-out unit R or image data transmitted to the image forming apparatus from an external device or the like.

The image read-out unit R includes an ADF (Auto Document Feeder) 9 capable of automatically carrying an original document up to a predetermined image read-out position, and reads out images of an original document loaded on a document tray (a predetermined document loading plate) Rt auto-carried by the ADF 9 or an image of an original document mounted on a not-shown document plate, by use of a scan optical system 10.

The image forming unit P includes pickup rollers 51 to 54, photoconductive members 2Y to 2K, development rollers 3Y to 3K, mixers 4Y to 4K, a middle transcript belt 6, a fixing device 7a and a discharge tray 8.

The image forming apparatus according to the present embodiment includes a CPU 801 and a memory 802 (see FIG. 1). The CPU 801 conducts a variety of processings in the image forming apparatus and also realizes a variety of functions by executing programs stored in the memory 802. The memory 802 may consist of, for example, a RAM (Random Access Memory), a ROM (Read Only Memory), a DRAM (Dynamic Random Access Memory), an SRAM (Static Random Access Memory), a VRAM (Video RAM), or the like and stores lots of information and programs used by the image forming apparatus.

A synopsis of a copying operation will now be described as an example of the processings by the image forming apparatus according to the present embodiment.

A sheet picked up from a cassette by one of the pickup rollers 51 to 54 is sent to a sheet carrying path. The sheet sent to the sheet carrying path is carried in a predetermined carrying direction by plural pairs of rollers.

Images of original documents of plural sheets which are successively auto-carried by the ADF 9 are read out at a predetermined image read-out position by the scan optical system 10.

Electrostatic latent images are formed on photoconductive surfaces of the photoconductive members 2Y, 2M, 2C and 2K to transcribe development agent images of yellow (Y), magenta (M), cyan (C) and black (K) on a sheet, based on image data of images read-out from the original documents by the image read-out unit R.

Subsequently, development agents stirred by the mixers 4Y to 4K (corresponding to stirring devices) of the development device are supplied to the photoconductive members 2Y to 2K on which the electrostatic latent images are formed in such way, by the development rollers (so-called mag-roller) 3Y to 3K. Thereby, the electrostatic latent images formed on the photoconductive surfaces of the photoconductive members are developed.

The development agent images formed on the photoconductive members in this way are transcribed onto a belt surface of the middle transcript belt 6 (so-called a primary transcript), and the development agent images carried by rotation of the middle transcript belt are transcribed onto sheets which are being carried, at a predetermined secondary transcript position T.

The development agent images transcribed onto the sheets are heated and fixed on the sheet by the fixing device 7a.

The sheets on which the development agent images are heated and fixed are carried into the carrying path by the plural pairs of carrying rollers and then are sequentially discharged on the discharge tray 8.

The fixing device according to the first embodiment of the present invention will be described in detail.

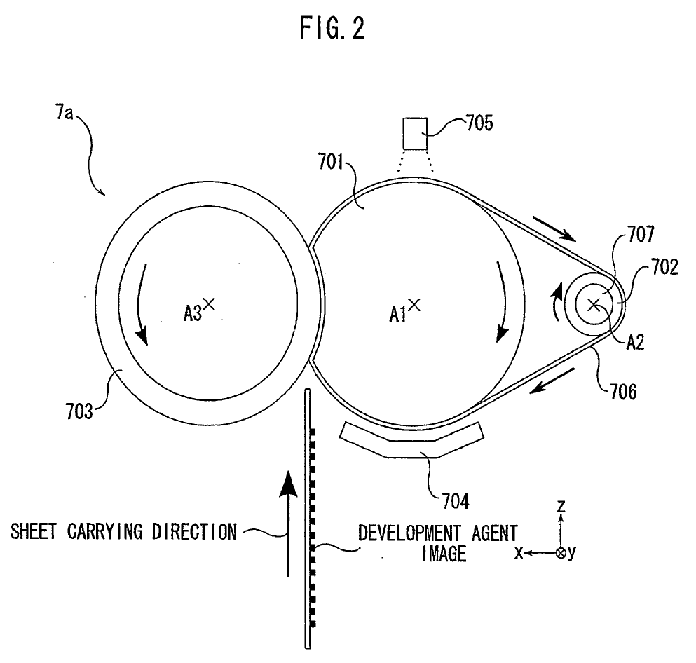

FIG. 2 is a longitudinal cross-sectional view to illustrate a schematic configuration of the fixing device according to the first embodiment of the present invention.

The fixing device 7a according to the first embodiment of the present invention includes a fixing roller (a first roller) 701, a tension roller (a second roller) 702, a press roller (a third roller) 703, an induction heating coil 704, a thermopile (a temperature sensor) 705, a belt 706 and a heat pipe 707.

The fixing roller (the first roller) 701 rotates with respect to a rotational axis A1. The fixing roller 701 contains a core and an elastic layer disposed on the outer circumference of the core. The core is fixed at a predetermined position of the fixing device. The core is made of steel and its outer diameter is set 30 mm. In addition, the elastic layer is made of foamy silicon rubber, which is 10 mm thick and its outer diameter is 50 mm.

The tension roller (the second roller) 702 rotates with respect to the rotational axis A2 parallel to the rotational axis A1 of the fixing roller 701. In detail, the tension roller 702 is configured of pipes made of steel, and its outer diameter is 17 mm and inner diameter is about 16 mm.

The belt 706 includes a metal layer (conductive layer) and is rolled on the fixing roller 701 and the tension roller 702.

The belt 706 includes a continuously variable belt made of nickel which has an inner diameter of 70 mm and a thickness of about 40 μm, and an elastic layer made of silicon rubber which is about 200 μm thick, disposed on the outer circumference of the continuously variable belt. An exfoliation layer is additionally disposed on (outermost part) the elastic layer, the exfoliation layer being about 30 μm thick and made of fluororesin (PFA (tetrafluoroethylene/perfluoroalkyl vinyl ether copolymer) or PTFE (Poly tetra fluoro ethylene) or a mixture of PFA and PTFE).

The induction heating coil 704 heats the belt 706 including the conductive layer by use of electromagnetic induction.

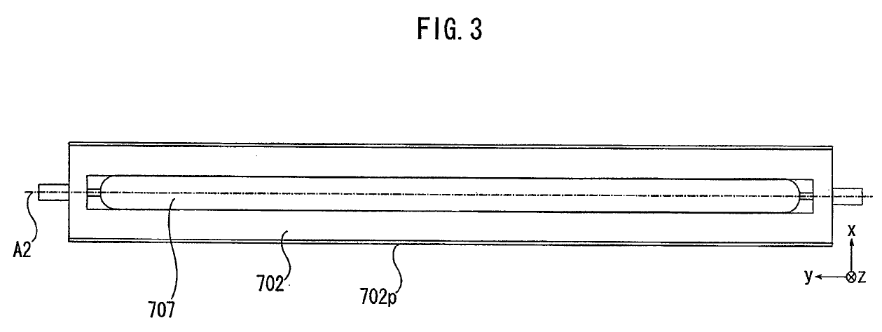

The heat pipe 707 is disposed inside the tension roller 702 and seems to have a shape extending in a direction of the rotational axis A2 of the tension roller 702. FIG. 3 is a view to explain an internal configuration of the tension roller 702.

The heat pipe has a structure that a small amount of liquid (working liquid) is sealed in vacuum in a closed container (here, a cylindrical shape extending toward a direction of the rotational axis A2) and the inner wall of the container has a capillary (wick).

In addition, the tension roller 702 has a cylindrical shape in at least a portion thereof, and the outer surface of the heat pipe 707 is disposed in order to contact closely to the inner surface of the tension roller 702. Disposing the heat pipe 707 as described above improves thermal conductivity, thermal response and uniformity of a temperature distribution of the tension roller 702. Furthermore, the heat pipe is embedded in the roller in this way and thereby can be used for temperature uniformity of the belt which rotates.

The roller surface of the tension roller 702 is coated with a tube 702p made of fluororesin.

Such configuration of the tension roller 702 and the heat pipe 707 can restrict occurrence of a surface temperature variation in a sheet widthwise direction of the tension roller 702.

The press roller (the third roller) 703 rotates with respect to the rotational axis A3, presses the roller surface of the fixing roller 701 through the belt 706, and nips and carries sheets to be treated in cooperation with the belt surface of the belt 706. Herein, the press roller (the third roller) 703 is assumed to press the fixing roller 701 by, for example, a not-shown elastic member such as a spring or a rubber.

In detail, the press roller 703 is configured of a core layer of which outer diameter is 45 mm, an elastic layer made of silicon rubber and 1 mm thick, provided on the outer circumference of the core layer, and an exfoliation layer made of fluororesin and 30 μm thick, provided on the outer circumference of the elastic layer. The core layer, the elastic layer and the exfoliation layer are fixed to each other by adhesive.

The thermopile (temperature sensor) 705 senses a belt surface temperature of the belt 706 in a non-contact manner. The CPU 801 controls a heating amount of the induction heating coil 704 on the basis of a temperature sensed by the thermopile 705. Programs to define a control table or a control algorithm which is referred to upon controlling the heating amount of the induction heating coil 704 are stored in, for example, the memory 802, and the CPU 801 executes the programs to realize the heating control of the induction heating coil 704.

In addition, as shown in FIG. 2, in the fixing device 7a of the present embodiment, the thermopile 705, the tension roller 702 and the induction heating coil 704 are disposed at different positions in the circumferential direction of the fixing roller 701.

Such configuration can lead to a space save and further a simple configuration of the device, thereby, with no relation to sizes in a direction (sheet widthwise direction) orthogonal to a carrying direction of sheets to be fixed, realizing uniformity of a sheet heating temperature in the sheet widthwise direction.

The thermopile 705, the tension roller 702 and the induction heating coil 704 are disposed at different positions in the circumferential direction of the fixing roller 701, and thereby the thermopile 705 sensing a temperature of the belt surface, the tension roller 702 giving a tension to the belt and the induction heating coil 704 heating the belt surface can be conducted at different positions in the circumferential direction of the fixing roller 701. Thereby, a space save of the arrangement space can be realized in a rotation radius direction of the fixing roller 701, and also the thermopile 705 measuring a temperature, the tension roller 702 to include the heat pipe making a temperature of the belt uniform and the induction heating coil heating belt can be realized without interfering each other.

In addition, the thermopile 705, the tension roller 702 and the induction heating coil 704 are arranged in sequence in the circumferential direction of the fixing roller 701, taking the nip position as a base point, from the upper side to the lower side of moving direction of the roller surface of the fixing roller 701.

Subsequently, a relation of lengths in a direction of rotational axis of the tension roller 702, an area heated by the induction heating coil 704, the belt 706 and the heat pipe 707 in the fixing device of the present embodiment will now be described.

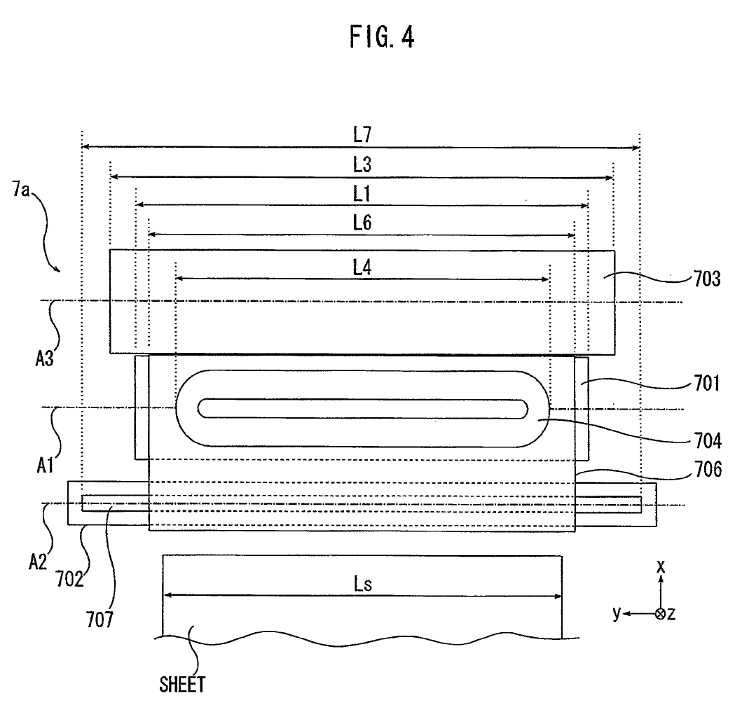

FIG. 4 is a schematic view to illustrate a relation of lengths in a direction of rotational axis of the tension roller 702, an area heated by the induction heating coil 704, the 706 and the heat pipe 707.

As shown in FIG. 4, the length L7 in a direction of the rotational axis A2 of an effective portion of the heat pipe 707 is configured to be larger than the length L4 in a direction of the rotational axis of the area heated by the induction heating coil 704.

Here, the “effective portion” refers to a portion where functions of thermal conductivity, thermal response and uniformity of a temperature distribution in the heat pipe 707 effectively work.

In addition, the “heated area” here refers to an area of the belt surface of the belt 706 which is substantially heated by the induction heating coil 704. A flux density may be considered as a method of defining a detailed heated area, for example.

In the length L7 in a direction of the rotational axis A2 of the effective portion of the heat pipe 707, a size (sheet width) in the direction of the rotational axis A2 preset for objects to be fixed by the fixing device 7a is set larger than a size (sheet width) Ls in the direction of the rotational axis A2 of the largest sheet (for example, A3 size).

In the length L4 in the direction of the rotational axis A2 of the area heated by the induction heating coil 704, a size in the direction of the rotational axis A2 preset for objects to be fixed by the fixing device 7a is set smaller than a size Ls in the direction of the rotational axis A2 of the largest sheet.

In addition, the size L6 in the direction of the rotational axis of the belt 706 is smaller than any size of the fixing roller 701, the tension roller 702 and the heat pipe 707 in the direction of the rotational axis A2.

The relation of L1, L3, L4, L6 and L7 in the present embodiment is as follows: L7>L3>L1>L6>Ls>L4.

In detail, the length L6 in the sheet widthwise direction of the belt 706 is 330 mm, larger than Ls=316 mm which is the largest sheet-passing width, which thus is a sufficient length for fixing operation.

The length L1 in the direction of the rotational axis A1 of the fixing roller 701 is set 340 mm, larger than the length L6 in the direction of the rotational axis of the belt 706.

The length L3 in the direction of the rotational axis of the press roller 703 is set 350 mm, larger than the length L1 in the direction of the rotational axis of the fixing roller 701.

In a relation of the heat pipe 707 inside the tension roller 702, the induction heating coil 704 and the largest sheet-passing width Ls, the length L7 of the effective portion of the heat pipe 707 is 330 mm, which is larger than the largest sheet-passing width Ls=316 mm.

The length L4 in the direction of the rotational axis A2 of the area heated by the induction heating coil 704 is 310 mm, which is smaller than the length L7 in the direction of the rotational axis A2 of the effective portion of the heat pipe 707 and the largest sheet-passing width Ls.

In order to heat the belt 706 such that the entire largest sheet-passing width Ls reaches a temperature in which a fixing is possible, the length L4 in the direction of the rotational axis A2 of the area heated by the induction heating coil 704 inherently needs to be equal to or larger than the largest sheet-passing width Ls. However, according to the fixing device 7a of the present embodiment, since the heat pipe 707 is embedded in the tension roller 702, a temperature of the end portion of the largest sheet-passing width Ls can be sufficiently increased due to the thermal conduction of the heat pipe, although the area heated by the induction heating coil 704 is smaller than the largest sheet-passing width Ls. Thereby, cost of overall devices can be reduced by downsizing the induction heating coil and conducting the fixing operation without problems.

Like the fixing device 7a according to the present embodiment, the thermopile 705 is disposed at the upper side of moving direction of the belt relative to the induction heating coil 704; thereby, after detecting a temperature using the thermopile 705 and in turn determining whether or not to heat, the induction heating coil 704 can heat the area if a heating is necessary.

Since the induction heating coil 704 is disposed right previously to the nip formed at a position where the press roller 703 and the belt 706 contact with each other and the belt 706 heated by the induction heating coil 704 enters the nip before its temperature is decreased, a high heating efficiency can be realized.

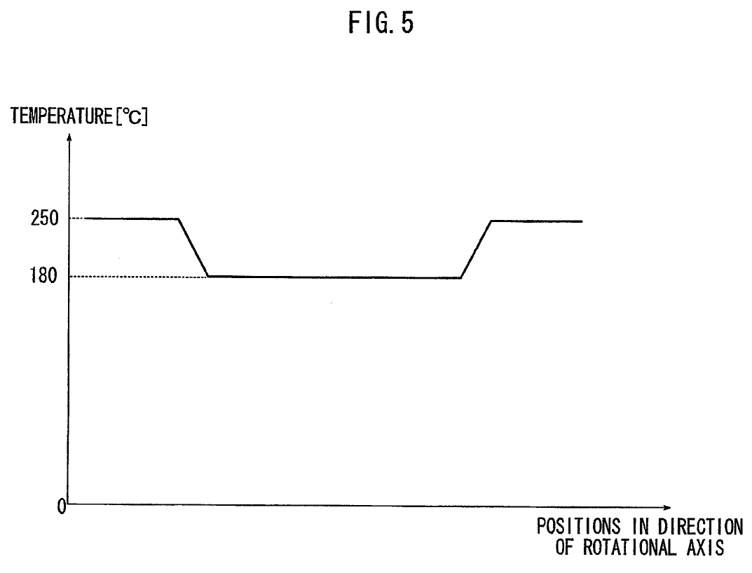

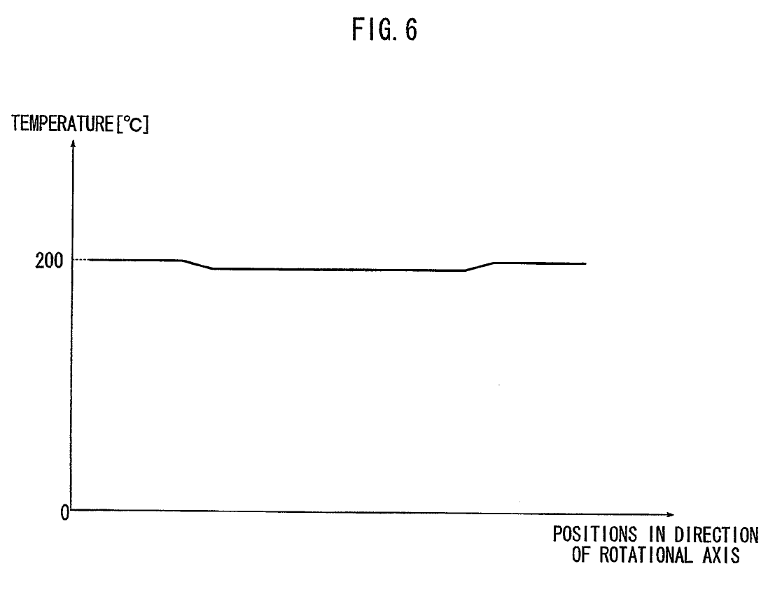

FIG. 5 is a graph to illustrate a temperature distribution in the direction of the rotational axis of the belt surface of the belt 706 when a narrow sheet is fixed in a configuration.of not providing the heat pipe 707 to the tension roller 702. FIG. 6 is a graph to illustrate a temperature distribution in the direction of rotational axis of the belt surface of the belt 706 when a narrow sheet is fixed in a configuration of providing the heat pipe 707 to the tension roller 702.

As shown in FIGS. 5 and 6, it can be known that the configuration according to the present embodiment can restrict occurrence of a temperature variation of the belt surface of the belt 706 in the direction of the rotational axis.

### Second Embodiment

A second embodiment of the present invention will now be described.

The second embodiment of the present invention is a modification of the above-described first embodiment. Hereinafter, elements having the same functions as those described in the first embodiment are given the same reference numerals, the description of which will be omitted. The present embodiment is different from the first embodiment in arrangement of the thermopile 705, the tension roller 702 and the induction heating coil 704.

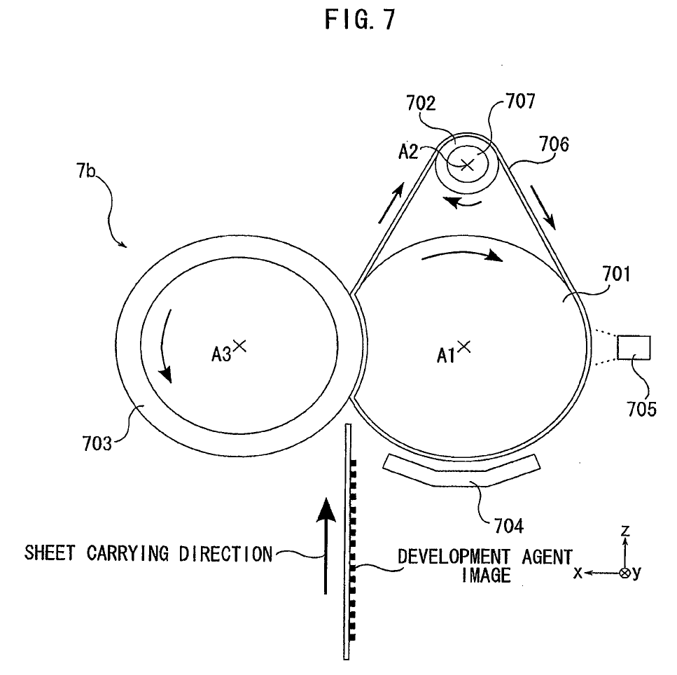

FIG. 7 is a longitudinal cross-sectional view to illustrate a schematic configuration of a fixing device 7b according to the second embodiment of the present invention.

As shown in FIG. 7, in the second embodiment of the present invention, the tension roller 702, the thermopile 705 and the induction heating coil 704 are arranged in sequence in the circumferential direction of the fixing roller 701, taking the nip position as a base point, from the upper side to the lower side of moving direction of the roller surface of the fixing roller 701.

The tension roller 702 can be disposed at a position right after the belt 706 passes through the nip, by the configuration according to the present embodiment. Such configuration can largely change a curvature of the belt right after passing through the nip and thus easily remove the sheet from the belt surface after the fixing, in addition to the effect obtained by the configuration according to the first embodiment.

### Third Embodiment

A third embodiment of the present invention will now be described.

The third embodiment of the present invention is a modification of the above-described first embodiment. Hereinafter, elements having the same functions as those described in the first embodiment are given the same reference numerals, the description of which will be omitted. The present embodiment is different from the above-described embodiments in arrangement of the thermopile 705, the tension roller 702 and the induction heating coil 704.

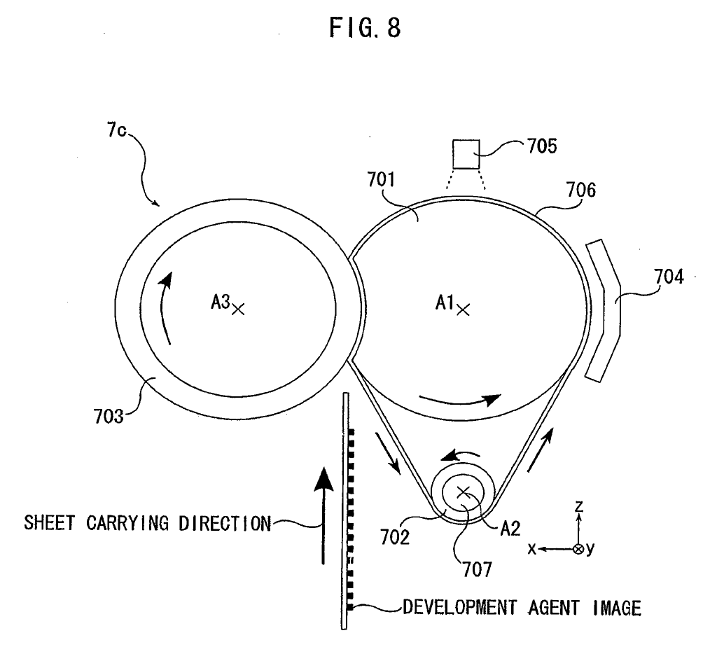

FIG. 8 is a longitudinal cross-sectional view to illustrate a schematic configuration of a fixing device 7c according to the third embodiment of the present invention.

As shown in FIG. 8, in the third embodiment of the present invention, the thermopile 705, the induction heating coil 704 and the tension roller 702 are arranged in sequence in the circumferential direction of the fixing roller 701, taking the nip position as a base point, from the upper side to the lower side of moving direction of the roller surface of the fixing roller 701.

According to the configuration according to the present embodiment, the tension roller 702 contacts with the belt right after the belt 706 is heated by the induction heating coil 704 and a temperature of the belt 706 can be made uniform by the heat pipe 707 embedded in the tension roller 702. Thereby, the belt 706 can enter the nip in a state of uniform temperature by the heat pipe 707, to realize a fixing leading to images of higher quality.

As such, the tension roller 702 including the heat pipe is disposed at the lower side than the induction heating coil and the upper side than the nip in the moving direction of the roller surface of the fixing roller 701; thus, a surface temperature of the belt heated by the induction heating coil can be made uniform by the tension roller 702 including the heat pipe before the belt enters the nip. Thereby, the heat added to sheets at the time of the fixing can be made uniform in the sheet widthwise direction to restrict occurrence of bad fixing.

Although the respective embodiments described above exemplify the configurations of employing the thermopile as a temperature sensor for sensing a temperature of the belt 706, the present invention is not necessarily limited thereto. In other words, a sensor which can finally sense a surface temperature of the belt 706, for example, a contact sensor may be employed.

Although the respective embodiments described above exemplify that the metal conductive layer made of nickel is employed as the conductive layer of the belt 706, not necessarily limited thereto, but a separate thing used for the conductive layer can also obtain the same effect as the present invention. For example, a thing which includes conductor powder and the like in a resin can be employed as the conductive layer of the belt 706.

The angular positions of the tension roller 702, the thermopile 705 and the induction heating coil 704 in the circumferential direction of the fixing roller 701 with respect to the rotational axis A1 of the fixing roller 701 are just examples in the respective embodiments described above, and, if an order of arrangement taking the nip as a base point is the same, it is obvious to show the same effect although the above-described angular positions go wrong.

Various modifications and alterations of this invention will be apparent to those skilled in the art without departing from the scope and spirit of this invention, and it should be understood that this is not limited to the illustrative embodiments set forth herein.

As described above in detail, the present invention can provide a technique to make uniform a temperature distribution of a sheet heating temperature in a sheet widthwise direction, with no relation to sizes in a direction (sheet widthwise direction) orthogonal to a carrying direction of sheets to be fixed.

What is claimed is:

1. A fixing device comprising:
a first roller;
a second roller configured to rotate with respect to a rotational axis parallel to a rotational axis of the first roller;
a belt configured to have a conductive layer and be rolled on the first roller and the second roller;
an induction heating coil configured to heat the belt;
a heat pipe configured to be disposed inside the second roller and extend toward the rotational axis of the second roller;
a third roller configured to press a roller surface of the first roller through the belt, to nip and carry a sheet to be treated in cooperation with a belt surface of the belt; and
a temperature sensor configured to sense a temperature of the belt surface of the belt,
wherein the temperature sensor, the second roller and the induction heating coil are disposed at different positions in a circumferential direction of the first roller.

2. The device according to claim 1, wherein the temperature sensor, the second roller and the induction heating coil are arranged in sequence in the circumferential direction of the first roller from the upper side to the lower side of moving direction of the roller surface of the first roller.

3. The device according to claim 1, wherein the second roller, the temperature sensor and the induction heating coil are arranged in sequence in the circumferential direction of the first roller from the upper side to the lower side of moving direction of the roller surface of the first roller.

4. The device according to claim 1, wherein the temperature sensor, the induction heating coil and the second roller are arranged in sequence in the circumferential direction of the first roller from the upper side to the lower side of moving direction of the roller surface of the first roller.

5. The device according to claim 1, wherein a length in the direction of the rotational axis of the second roller of an effective portion of the heat pipe is larger than a length in the direction of the rotational axis of an area heated by the induction heating coil.

6. The device according to claim 1, wherein, in a length in the direction of the rotational axis of the second roller of an effective portion of the heat pipe, a size in the direction of the rotational axis preset for objects to be fixed by the fixing device is larger than a size in the direction of the rotational axis of the largest sheet.

7. The device according to claim 1, wherein, in a length in the direction of the rotational axis of an area heated by the induction heating coil, a size in the direction of the rotational axis preset for objects to be fixed by the fixing device is smaller than a size in the direction of the rotational axis of the largest sheet.

8. The device according to claim 1, wherein the second roller has a cylindrical shape in at least a portion thereof, an outer surface of the heat pipe is disposed in order to contact closely with an inner surface of the second roller, and the roller surface of the second roller is coated with fluororesin.

9. The device according to claim 1, wherein a size in a direction of a rotational axis of the belt is smaller than any size of the first roller, the second roller and the heat pipe in the direction of the rotational axis.

10. The device according to claim 1, wherein the temperature sensor is a thermopile.

11. A fixing method in a fixing device including: a first roller; a second roller configured to rotate with respect to a rotational axis parallel to a rotational axis of the first roller; a belt configured to have a conductive layer and be rolled on the first roller and the second roller; an induction heating coil configured to heat the belt; a heat pipe configured to be disposed inside the second roller and extend toward the rotational axis of the second roller; a third roller configured to press a roller surface of the first roller through the belt, to nip and carry a sheet to be treated in cooperation with a belt surface of the belt; and a temperature sensor configured to sense a temperature of the belt surface of the belt,
wherein the temperature sensor sensing a temperature of the belt surface, the second roller giving a tension to the belt and the induction heating coil heating the belt surface are conducted at different positions in a circumferential direction of the first roller.

12. The method according to claim 11, wherein the temperature sensor, the second roller and the induction heating coil are arranged in sequence in the circumferential direction of the first roller from the upper side to the lower side of moving direction of the roller surface of the first roller.

13. The method according to claim 11, wherein the second roller, the temperature sensor and the induction heating coil are arranged in sequence in the circumferential direction of the first roller from the upper side to the lower side of moving direction of the roller surface of the first roller.

14. The method according to claim 11, wherein the temperature sensor, the induction heating coil and the second roller are arranged in sequence in the circumferential direction of the first roller from the upper side to the lower side of moving direction of the roller surface of the first roller.

15. The method according to claim 11, wherein a length in the direction of the rotational axis of the second roller of an effective portion of the heat pipe is larger than a length in the direction of the rotational axis of an area heated by the induction heating coil.

16. The method according to claim 11, wherein, in a length in the direction of the rotational axis of the second roller of an effective portion of the heat pipe, a size in the direction of the rotational axis preset for objects to be fixed by the fixing device is larger than a size in the direction of the rotational axis of the largest sheet.

17. The method according to claim 11, wherein, in a length in the direction of the rotational axis of an area heated by the induction heating coil, a size in the direction of the rotational axis preset for objects to be fixed by the fixing device is smaller than a size in the direction of the rotational axis of the largest sheet.

18. The method according to claim 11, wherein, the second roller has a cylinder shape in at least a portion thereof, an outer surface of the heat pipe is disposed in order to contact closely with an inner surface of the second roller, and the roller surface of the second roller is coated with fluororesin.

19. The method according to claim 11, wherein a size in a direction of a rotational axis of the belt is smaller than any size of the first roller, the second roller and the heat pipe in the direction of the rotational axis.

20. The method according to claim 11, wherein the temperature sensor is a thermopile.
